(19) United States
(12) Patent Application Publication
(10) Pub. No.: US 2011/0283710 A1
(43) Pub. Date: Nov. 24, 2011

(54) Synthesis gas-based fuel system including admixture of a second fuel, and method for the operation of a synthesis gas-based fuel system

(76) Inventors: Christian Brunhuber, Auerbach (DE); Jens Keyser, Furth (DE); Oliver Reimuth, Erlangen (DE)

(21) Appl. No.: 13/146,210

(22) PCT Filed: Jan. 8, 2010
(86) PCT No.: PCT/EP10/50160

§ 371 Date: Jul. 26, 2011

(30) Foreign Application Priority Data
Jan. 26, 2009 (EP) 09151309.3

(51) Int. Cl. F02C 3/28; F02C 7/224; F02C 3/20

(52) U.S. Cl. 60/780; 60/39.12; 60/39.463; 60/736

(57) ABSTRACT

A synthesis gas-based fuel system with a main synthesis gas pipe which branches off a gasification device and ends at a transfer point is described. The main gas pipe is connected to a burner. A device for admixing a second fuel and, downstream there from in a direction of flow of a synthesis gas, a mixing device are arranged within the main synthesis gas pipe. Further, a method for operating the synthesis gas-based fuel system for rapid load changes in a synthesis gas-operated gas turbine is provided.

### CROSS REFERENCE TO RELATED APPLICATIONS

This application is the U.S. National Stage of International Application No. PCT/EP2010/050160 filed Jan. 8, 2010, and claims the benefit thereof. The International Application claims the benefits of European Patent Application No. 09151309.3 EP filed Jan. 26, 2009. All of the applications are incorporated by reference herein in their entirety.

### FIELD OF INVENTION

The invention relates to a syngas fuel system, in particular for a combined cycle gas turbine (CCGT) system, and relates to the problem of rapid changes in the load on the gas turbine, such as are produced for example by the demands of the British grid code. The invention relates further to a method for operating a syngas fuel system for rapid changes in the load on a gas turbine when in syngas operation.

### BACKGROUND OF INVENTION

The use of a gasification power station (IGCC—Integrated Gasification Combined Cycle), where the production of synthesis gases is followed by their use in a CCGT is seen as an alternative to conventional steam power stations (DKW), above all in terms of the potential efficiency advantages of using a CCGT compared to a DKW. An important factor for the operation of an IGCC system is the syngas fuel system, upstream from the CCGT, the individual components of which comprise nitrogen dilution, water/steam saturation, admixture of natural gas, air extraction and heat exchangers.

The object of the syngas fuel system is to provide a conditioned syngas appropriate for the temperature and calorific value requirements of the consumer, the gas turbine, which lies downstream and, in the case where an air side is integrated, the provision of compressed air for its integrated use in the air separation plant. The conditioning, and thus the setting of the calorific value, of the raw syngas present at the entrance to the syngas fuel system is effected by means of the above-mentioned individual components/systems. The temperature of the conditioned syngas is adjusted before its exit from the syngas fuel system, using a heat exchanger. In the case of (partly) integrated air extraction, the compressed air is taken from the gas turbine compressor, and for non-integrated air extraction from a separate compressor, and it is adjusted to the temperature level required by the air separation plant by means of integral heat exchangers. DE 100 02 084 C2 describes such a plant.

Because of its interaction with the main systems of the IGCC which are involved (air separation plant, gasification, washing, CCGT), the syngas fuel system is currently engineered as a subsystem of the overall system, with base-load capabilities which cannot accommodate steep gradients in the load on the gas turbine, represented by increases in the calorific value.

There are increasing requirements for the availability of a way of operating with steep gradients in the load on the gas turbine in an IGCC configuration which utilizes syngas operation, and hence the syngas fuel system must be adapted for these changed external conditions, as far as possible independently of, and with only limited effects on, the neighboring main systems.

A device or method, as applicable, is known from EP 1 277 920 A1 where a power station has a gas turbine to which is assigned a combustion chamber with at least one burner, and has a fuel system, upstream from the combustion chamber, which incorporates a gasification device for fossil fuels and a gas pipe which branches off from the gasification device and which opens out into the combustion chamber. Here, the CCGT plant can be operated not only with the syngas but also with a second fuel, such as for example natural gas or oil. For this purpose, the burner is arranged as a dual-fuel or multi-fuel burner. By the admixture of natural gas or steam to the syngas, its calorific value can be adjusted. In the case of the method for operating a burner in a gas turbine, a fossil fuel is gasified and gasified fossil fuel is fed to the burner associated with the gas turbine as syngas for combustion.

The disadvantages of this are that when there is an increase in the load the requirements of a steep load gradient will not be met even if natural gas is added to the syngas, because the size and length of the construction of the apparatuses and their arrangement causes a delay in the flow of the fuel mass flow until it reaches the gas turbine, or that the short term admixture of natural gas, possibly in large quantities, associated with the load change makes selective adjustment of the calorific value of the combustion gas more difficult.

### SUMMARY OF INVENTION

An object is to further develop the device and method mentioned so that requirements for a steep load gradient are satisfied.

The object is achieved by a device and a method in accordance with the independent claims. Advantageous developments of the invention are defined in the relevant dependent claims.

By arranging a second fuel admixture device and a blender in the main syngas pipe, where the blender is arranged downstream from the second fuel admixture device in the direction of flow of syngas, the following are achieved:

The necessary calorific value and combustion gas mass flow are provided for a rapid rise in the load when there is a temporary shortage of syngas due to the limited load gradient of the gasifier, wherein the blender ensures a particularly uniform and streamer-free mixing of the second fuel with the syngas, so that it is possible to adjust the calorific value of the syngas/second fuel mixture precisely as required.

In one advantageous embodiment, the second fuel admixture device is arranged in the main syngas pipe at least near to, if not immediately before, the transfer point at which the pipe is connected to a burner. A rapid load increase for the complete IGCC system is linked to the rapid availability of the usable fuel mass flow (syngas plus second fuel) combined with an adequate calorific value. Because of the delay before the flow of the fuel mass flow reaches the gas turbine, when a second fuel is used for increasing the fuel mass flow and calorific value in the event of a rapid increase in load, attention must be given to injecting it as close as possible to the gas turbine.

Here, it is expedient if a fuel pipe opens into the second fuel admixture device and a regulating valve is incorporated into the fuel pipe. The regulating valve ensures that the quantity and pressure of the natural gas is precisely regulated as a function of the predefined ratio of second fuel/syngas and of the permissible calorific value.

Here, it is advantageous if a calorific value measuring instrument is arranged downstream from the blender, in the direction of flow of the syngas, for making measurements to control the adherence of the combustion gas mixture to the predefined calorific value.

In an advantageous way, means are provided by which a calorific value, determined by the calorific value measuring instrument, is communicated to the regulating valve so that the amount of the second fuel admixed can be readjusted.

It is of further advantage if the fuel pipe incorporates a heat exchanger so that, before the admixture of the second fuel, the second fuel can be pre-heated to a temperature level which deviates sufficiently from the saturation curve for the syngas.

It is expedient if the blender is a filter. A filter, which is in any case required in the main syngas pipe, can in an advantageous way be used also for the blending of the syngas/second fuel mixture, in that it is not arranged in any other position, but in the main syngas pipe behind the second fuel admixture device in the direction of flow of the syngas.

It is expedient that the second fuel admixture device is a natural gas admixture device. Because of its high calorific value, natural gas permits a particularly rapid load change to be effected.

In a combined cycle gas turbine system with a gas turbine, a combustion chamber and a syngas fuel system, it is advantageous if the transfer point of the fuel system is connected to a burner in the combustion chamber.

In the inventive method for operating a syngas fuel system for rapid load changes on a gas turbine in syngas operation, a second fuel is admixed to a syngas and the syngas/second fuel mixture is blended and fed to a combustion chamber of the gas turbine.

It is advantageous if the admixture and blending take place directly upstream from the combustion chamber.

Advantageously, the admixture of the second fuel will be regulated. It is expedient if this is effected as a function of the calorific value of the syngas/second fuel mixture, which is measured for this purpose.

It is advantageous if the second fuel is pre-heated.

It is further of advantage if the syngas is conditioned, before the second fuel is admixed.

### BRIEF DESCRIPTION OF THE DRAWINGS

The invention is explained in more detail below by reference to the drawings. These show, schematically and not to scale:

FIG. 1 a known syngas fuel system,

FIG. 2 a syngas fuel system in accordance with the invention with a second fuel admixture device, and

FIG. 3 a graph over time of the power, syngas mass flow and second fuel mass flow when there in a rise in the load.

### DETAILED DESCRIPTION OF INVENTION

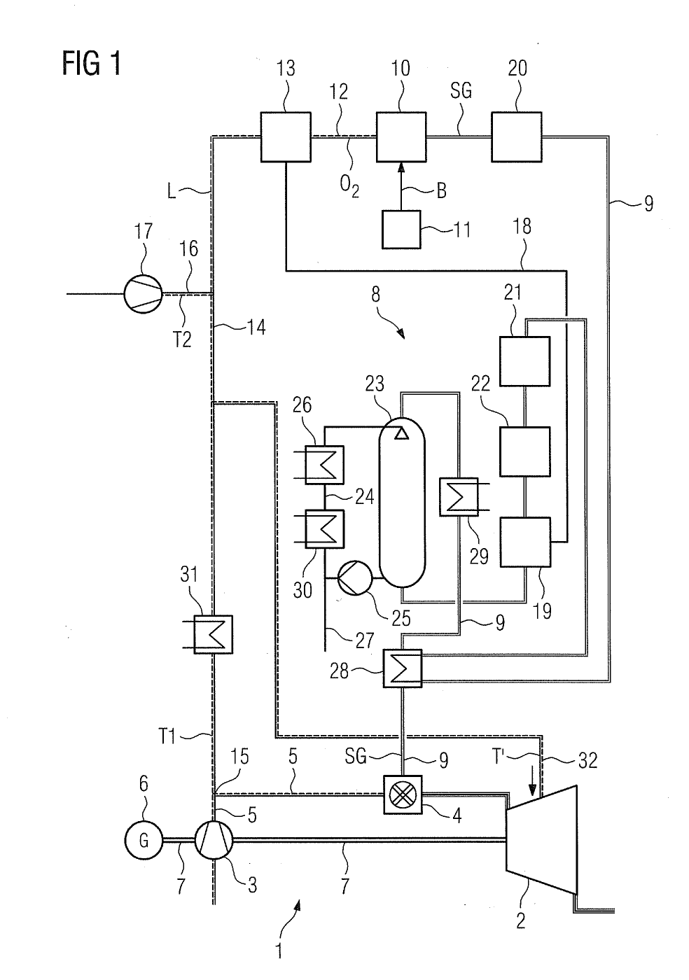

A familiar combined cycle gas turbine system includes a gas turbine system 1 as shown in FIG. 1 and a steam turbine system, not shown in more detail. The gas turbine system 1 incorporates a gas turbine 2 with an air compressor 3 coupled to it and, upstream from the gas turbine 2, a combustion chamber 4 which is connected to a compressed air pipe 5 from the compressor 3. Together with a generator 6, the gas turbine 2 and the air compressor 3 are mounted on a common shaft 7.

The gas turbine system 1 is arranged for operation with a gasified crude gas or syngas SG, generated by the gasification of a fossil fuel B. The syngas provided could be, for example gasified coal or gasified oil. For this purpose, the gas turbine system 1 includes a syngas fuel system 8, via which syngas can be fed to the combustion chamber 4 of the gas turbine 2. The syngas combustion system 8 includes a main syngas pipe 9, which joins a gasification device 10 to the combustion chamber 4 of the gas turbine 2. Via a charging system 11 it is possible to feed a fossil fuel B, for example coal, natural gas, oil or biomass, to the gasification device 10. Furthermore, the syngas fuel system 8 includes components which are connected in line in the main syngas pipe 9 between the gasification device 10 and the combustion chamber 4 of the gas turbine 2.

For the purpose of providing the oxygen O₂ required for the gasification of the fossil fuel B, the gasification device has an air separation system 13, connected in line in front of it via an oxygen pipe 12. On its input side, the air separation system 13 can be fed with an air flow L, which is made up of a first partial flow T1 and a second partial flow T2. The first partial flow T1 can be tapped from the air compressed in the air compressor 3. For this purpose, the input side of the air separation system 13 is connected to a tapped air pipe 14 which branches off from the compressed air pipe 5 at a branch point 15. In addition, opening into the tapped air pipe 14 is a further air pipe 16, in which a supplementary air compressor 17 is connected in line and through which the second partial flow T2 can be fed to the air separation system 13. In the exemplary embodiment, the total air flow L which flows to the air separation system 13 is made up of the partial flow T1 branched off from the compressed air pipe 5 (less a partial quantity T′ which is explained below) and the air flow T2 supplied from the supplementary air compressor 17. Such a circuit design is also referred to as a partially-integrated system concept. In an alternative embodiment, the so-called fully-integrated system concept, the other air pipe 16 together with the supplementary air compressor 17 can be omitted, so that the air separation system 13 is fed with air entirely via the partial flow T1 tapped from the compressed air pipe 5.

To retrieve heat from the tapped air, a heat exchanger 31 is connected in line in the tapped air pipe 14, by which means it is possible to achieve a particularly high efficiency for the combined cycle gas turbine.

Behind the heat exchanger 31, looking in the direction of flow of the partial flow T1, a cold air pipe 32 branches off from the tapped air pipe 14, through which a part T′ of the cooled air flow T1 can be fed to the gas turbine 2 as cold air for cooling the vanes.

The nitrogen N₂, which is obtained in addition to the oxygen O₂ in the air separation system 13 when the air stream L is separated, is fed via a nitrogen pipe 18, which is connected to the air separation system 13, to a mixing device 19 and there it is admixed with the syngas SG. Here, the mixing device 19 is embodied for particularly uniform and streamer-free mixing of the nitrogen N₂ with the syngas SG.

The syngas SG which flows away from the gasification device 10 passes initially, via the main syngas pipe 9, into a syngas waste heat steam generator 20, in which a cooling of the syngas SG is effected by heat exchange with a fluid medium. High-pressure steam generated during this heat exchange can be fed, in a way not explained in more detail here, to a high-pressure stage in a water/steam circuit of a steam turbine system.

A dust removal device 21 for the syngas SG, together with a desulphurization system 22, are connected in line in the main syngas pipe 9, behind the syngas waste heat steam generator 20 and before a mixing device 19 when looking in the direction of flow of the syngas SG. In an alternative embodiment, particularly when oil is being gasified as the fuel, it is also possible to provide instead of a dust removal device 21 a carbon particle washing device.

To achieve particularly low emissions of pollutants from the combustion of the gasified fuel in the combustion chamber 4, provision is made to charge the gasified fuel with steam before its entry into the combustion chamber 4. From a heat technology point of view, this can be effected particularly advantageously in a saturation system. For this purpose, a saturator 23 is connected in line in the main syngas pipe 9, in which the gasified fuel is fed as a countercurrent to the heated saturator water. Here, the saturator water circulates in a saturator circuit 24 which is connected to the saturator 23 and in which are connected in line a circulation pump 25 together with a heat exchanger 26 for pre-heating the saturator water. To compensate for the losses of saturator water which arise during the saturation of the gasified fuel, a feed pipe 27 is connected to the saturator circuit 24.

Behind the saturator 23, looking in the direction of flow of the syngas SG, a heat exchanger 28 is connected in line in the main syngas pipe 9 and on the secondary side acts as a syngas/mixed gas heat exchanger. Here, the primary side of the heat exchanger 28 is connected in line at a point before the dust removal device 21, again in the main syngas pipe 9, so that the syngas SG flowing to the dust removal device 21 transfers a proportion of its heat to the syngas SG flowing out of the saturator 23. A feed of the syngas SG through the heat exchanger 28 before it enters the desulphurization system 22 can also be provided if a connection arrangement is used which differs in respect of the other components. In particular, if a carbon particle washing device is connected in line, the heat exchanger can preferably be arranged downstream on the syngas side from the carbon particle washing device.

A further heat exchanger 29, which on the primary side can be heated by a water supply or even steam, is connected on the secondary side in line in the main syngas pipe 9, between the saturator 23 and the heat exchanger 28. The heat exchanger 28 which is embodied as a syngas/pure gas heat exchanger and the heat exchanger 29 together ensure particularly reliable pre-heating of the syngas SG flowing to the combustion chamber 4 of the gas turbine 2, even in the most varied operating states of the combined cycle gas turbine system.

For the purpose of injecting heat into the saturator circuit 24 there is not only the heat exchanger 26 which can, for example, be fed with a supply of heated water tapped off after a water supply pre-heater, but also provided is a saturator water heat exchanger 30 which on its primary side can be fed with a water supply from a water supply container, which is not shown.

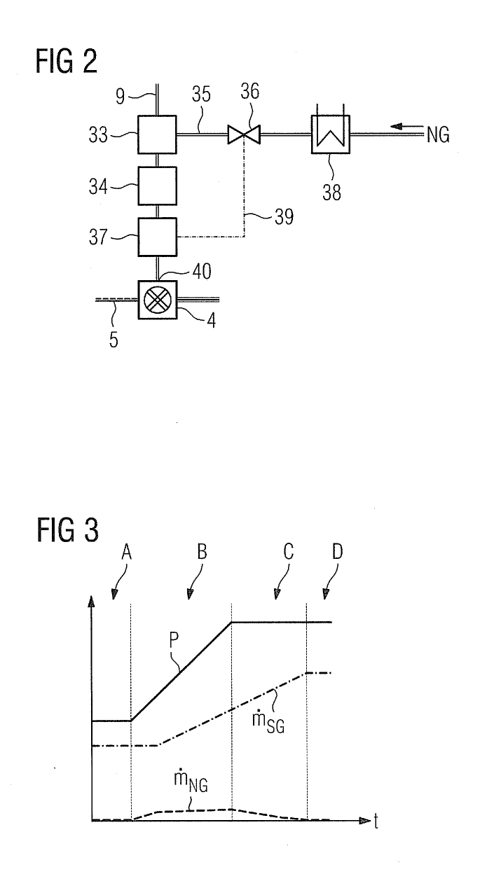

FIG. 2 describes the inventive syngas fuel system 8 with a transfer point 40 at the end of the main syngas pipe 9, for a connection to a burner in the combustion chamber 4 of a gas turbine 2, wherein a second fuel admixture device 33 for the admixing of natural gas to the conditioned syngas is arranged before a blender 34 and the main regulating valve (not shown) of the gas turbine 2.

The blender 34 is a filter which, apart from its filtration function, works as a blender of the conditioned syngas and the admixed second fuel (natural gas).

The injection of natural gas for the admixture is here effected via a fuel pipe 35 which opens out into the second fuel admixture device 33 and in line in which is connected a regulating valve 36 which ensures precise regulation of the quantity and pressure of the natural gas as a function of the predefined ratio of natural gas/conditioned syngas and of the permissible calorific value.

The control measurements for effecting adherence to the predefined calorific value for the fuel gas mixture after the admixing are effected using a fast calorific value measuring instrument 37, in order that rapid changes in the calorific value are forwarded 39 to the regulating section of the natural gas admixture system.

Depending on the primary heat transmission medium which is available for superheating the syngas, and on the water content of the conditioned syngas, the natural gas must be pre-heated before it is admixed, using a heat exchanger 38, to a temperature level which deviates sufficiently from the saturation curve of the syngas.

FIG. 3 shows a graph against time of the power P, syngas mass flow \dot{m}_{SG} and mass flow \dot{m}_{NG} of the second fuel when there is a load increase. During the time period A, the load or power P, as applicable, is constant. The syngas mass flow \dot{m}_{SG} is thus also constant, and the mass flow \dot{m}_{NG} of the second fuel is zero. If there is a rapid rise in the load, the power P should be raised to a higher value within a prescribed time interval B. If the increase in the syngas mass flow \dot{m}_{SG} cannot be effected sufficiently quickly, a second fuel is admixed to the syngas, so that the mass flow \dot{m}_{NG} of the second fuel is then not zero. When the target level for the power P is reached, the admixture of the second fuel can be slowly restricted over the time period C, i.e. the mass flow \dot{m}_{NG} of the second fuel approaches zero again, while the syngas mass flow \dot{m}_{SG} increases further until the fuel requirement can be completely covered by the syngas (time period D).

1.-16. (canceled)

17. A syngas fuel system, comprising:
a gasification device;
a burner;
a main syngas pipe which branches off from the gasification device and terminates in a transfer point for a connection to the burner; and
an admixture device for a second fuel and a blender which are arranged in the main syngas pipe,
wherein the blender is arranged after the admixture device for the second fuel in a flow direction of a syngas.

18. The syngas fuel system as claimed in claim 17, wherein the admixture device for the second fuel is arranged in a region of the transfer point.

19. The syngas fuel system as claimed in claim 17, wherein the admixture device for the second fuel is arranged immediately before the transfer point in the flow direction of the syngas.

20. The syngas fuel system as claimed in claim 17, wherein a fuel pipe is connected to the admixture device for the second fuel.

21. The syngas fuel system as claimed in claim 20, wherein the fuel pipe includes a regulating unit.

22. The syngas fuel system as claimed in claim 17, wherein a calorific value measuring instrument is arranged after the blender in the flow direction of the syngas.

23. The syngas fuel system as claimed in claim 22, wherein communication device communicates a calorific value determined by the calorific value measuring instrument to the regulating unit.

24. The syngas fuel system as claimed in claim 20, wherein a heat exchanger is connected in line in the fuel pipe.

25. The syngas fuel system as claimed in claim 17, wherein the blender is a filter.

26. The syngas fuel system as claimed in claim 17, wherein the admixture device for the second fuel is a natural gas admixture device.

27. A combined cycle gas turbine, comprising:
a gas turbine;
a combustion chamber; and
a syngas fuel system comprising
a gasification device,
a burner,
a main syngas pipe which branches off from the gasification device and terminates in a transfer point for a connection to the burner, and
an admixture device for a second fuel and a blender which are arranged in the main syngas pipe, wherein the blender is arranged after the admixture device for the second fuel in a flow direction of a syngas,
wherein the transfer point is connected to a further burner in the combustion chamber.

28. A method for operating a syngas fuel system for rapid load changes on a gas turbine in syngas operation, comprising:
admixing a second fuel with a syngas resulting in a syngas-second fuel-mixture; and
blending and feeding the syngas-second fuel-mixture to a combustion chamber of a gas turbine.

29. The method as claimed in claim 28, wherein the admixing and the blending are effected immediately upstream from the combustion chamber.

30. The method as claimed in claim 28, wherein the admixing of the second fuel is regulated.

31. The method as claimed in claim 28, wherein a calorific value of the syngas-second fuel-mixture is measured for the regulating of the admixing of the second fuel.

32. The method as claimed in claim 28, wherein the second fuel is pre-heated.

33. The method as claimed in claim 28, wherein the syngas is conditioned before the second fuel is admixed.
